(19) United States
(12) Patent Application Publication
(10) Pub. No.: US 2006/0005151 A1
(43) Pub. Date: Jan. 5, 2006

(54) Graphical interface for adjustment of text selections

(75) Inventor: Adam E. Altman, San Jose, CA (US)

Correspondence Address: ADOBE SYSTEMS, INCORPORATED;c/o PARK, VAUGHAN & FLEMING LLP, 2820 FIFTH STREET, DAVIS, CA, 95616-2914, US

(73) Assignee: Adobe Systems

(21) Appl. No.: 10/884,615

(22) Filed: Jul. 2, 2004

(51) Int. Cl. G06F 3/00

(52) U.S. Cl. 715/860

(57) ABSTRACT

A computer implemented technique for manipulation of either endpoint of a selected text. One method includes selecting a subset of substantially sequential discrete tokens from a set of available discrete tokens on a human interface device by placing a interface adjustment element on either endpoint of the subset of substantially sequential discrete tokens to be selected. The placed interface adjustment element on either endpoint of the subset of substantially sequential discrete tokens is manipulated individually using a user interface device to perform the adjustment to either endpoint of the selection of the subset of substantially sequential discrete tokens.

### TECHNICAL FIELD OF THE INVENTION

The present invention relates generally to computer interfaces, and more particularly relates to graphical interface for manipulations of element selections.

### BACKGROUND OF THE INVENTION

Generally, computer systems include graphical user interfaces. Graphical user interfaces typically include a user interface window, more commonly referred to as a desktop window. While operating within the desktop window computer users are able to manipulate discrete tokens, such as text using a cursor control device.

Currently, when a computer user wants to perform an operation on a block of text, the user first selects the text and then performs the operation. Often, because of small font size, inadequate motor control, and/or other such factors, the selection of the text does not exactly match what the computer user had intended to select and usually ends up requiring adjustment to the selection.

Most text manipulation programs today allow selections to be adjusted, but only at one endpoint of the selection and in some applications before completing the selection. These text selections are generally defined by two endpoints and contain all of the characters between those two endpoints in a reading order. When creating the text selections, generally one endpoint is fixed while the other can be changed. When using the cursor control device, the first selection point usually defines the fixed endpoint, while dragging the cursor control device moves the other endpoint. This fixed endpoint is generally referred to as the “anchor” endpoint of the selection.

Once placed, the anchor endpoint of the selection cannot be moved. If both endpoints of the selection need adjustment or the anchor endpoint needs adjustment, the computer user is generally forced into either to start over with a new text selection, or to perform the intended operation on the incorrect selection and use smaller sections to either extend or undo portions of the text selection operation. In extreme cases, users who would typically create and manipulate selections using a cursor control device or other such point device have to revert to using the keyboard to make accurate text selections. This can result in unintended additional operations to perform the intended operation. Therefore, there is a need for a graphical interface that provides for adjustment of either endpoint of text selections. There is also a need for a graphical interface that allows computer users to more easily make accurate text selections. In addition, there is a need for simplified graphical interface when manipulating the text selections. Furthermore, there is a need to provide a sense of better control to the computer user during text selections.

### SUMMARY OF THE INVENTION

The present invention provides a graphical interface technique for manipulating either one of endpoints of a selection of subset of substantially sequential discrete tokens. In one example embodiment, the manipulation of either endpoint of a selection of the subset of substantially sequential discrete tokens is performed by selecting a subset of substantially sequential discrete tokens from a set of available substantially sequential discrete tokens on a human interface device. The selection is performed by placing an interface adjustment element on each one of endpoints of the subset of substantially sequential discrete tokens to be selected. The interface adjustment element placed at either one of the endpoints is manipulated individually while the interface adjustment element placed at the other one of the endpoints is being held fixed during the manipulation to make a new selection of substantially sequential discrete tokens.

### BRIEF DESCRIPTION OF THE DRAWINGS

FIGS. 1-12 are screen shot representations that illustrate a sequence of user interface operations performed during adjustment of either endpoint of a selected text according to an embodiment of the present invention.

FIG. 13 is a flowchart of a method of performing adjustment to either endpoint of a subset of substantially sequential discrete tokens selection according to an embodiment of the present invention.

FIG. 14 is a flowchart of a method of performing adjustment to either endpoint of each of multiple subsets of substantially sequential discrete tokens selection according to the various embodiments of the present invention.

FIG. 15 is a block diagram of a typical computer system for performing selected functions related to the adjustment of either endpoint of discrete tokens selection according to an embodiment of the present invention.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. In further embodiments, some of the functions are performed by users. The term “computer readable media” is also used to represent carrier waves on which the software is transmitted. Further, such functions correspond to modules, which are software, hardware, firmware or any combination thereof. Multiple functions are performed in one or more modules as described, and the embodiments described are merely examples.

The term “discrete token” will be understood to mean unconnected distinct element, i.e., constituting a separate element. For example, each letter in a text data constitutes a discrete token. Also, the term “drag handle” means an interface adjustment element that can be selected and manipulated using a user input device, such as a mouse and a trackball in a computer system. In addition, the term “endpoint” means edge of a selection of discrete tokens.

In one embodiment of the invention a drag handle is placed at either endpoint to make adjustments to either endpoint of a text selection. Screen shots are used in this description to illustrate the process of making the adjustments to either endpoint of the text selection, followed by a flowchart of the process. Some examples of instructions for implementing the process are also provided along with a description of an example computer system for implementing the process. The language “to make adjustments to either endpoint of a text selection” refers to the ability to make adjustments to either one of endpoints of the selection while the other endpoint is held fixed. Also, the language refers to having the ability to make the adjustment in either direction of a selected endpoint to adjust, i.e., to the left or right of the selected endpoint to adjust while the other endpoint is held fixed.

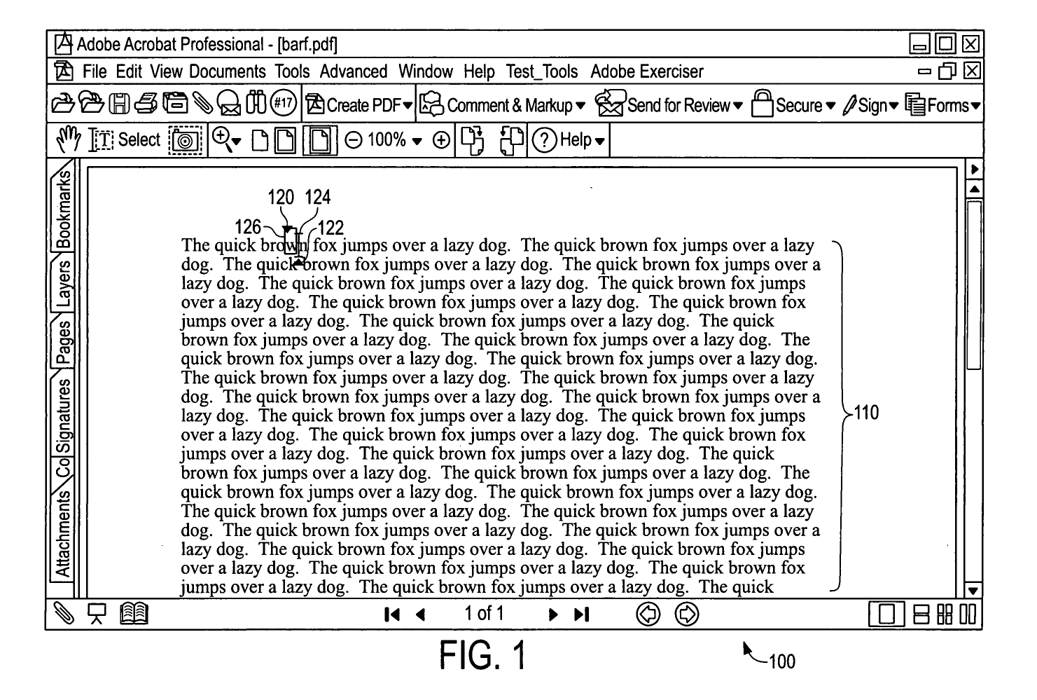

FIG. 1 shows a screen shot 100 of an example embodiment of starting a selection of a block of text data from text data 110 presented in a window of a text application, such as a word processor on a computer display screen of a computer system. Also shown in the screen shot 100, is a pair of drag handles in the form of a downward pointing arrow handle 120 and an upward pointing arrow handle 122, respectively, and a cursor 124 presented in the window of the text application.

It can be envisioned that the pair of drag handles 120 and 122 can be any pointing symbols that provides a cue to a computer user that they can be individually manipulated. As explained above, the pair of drag handles 120 and 122 is interface adjustment elements that can be displayed on the computer display screen of the computer system. Further, the pair of drag handles 120 and 122 can be selected and manipulated using a user input device, such as a mouse, joystick, digitizing tablet, electronic stylus, touch screen, voice activated device, trackball and the like.

As shown in the screen shot 100, the selection of the block of text data is started by positioning the cursor 124 at a first endpoint 126 of the block of text data to be selected and selecting the cursor position at the first endpoint 126 using the user input device to place the downward pointing arrow handle 120 and the upward pointing arrow handle 122 at the first endpoint 126 of the block of text data to be selected.

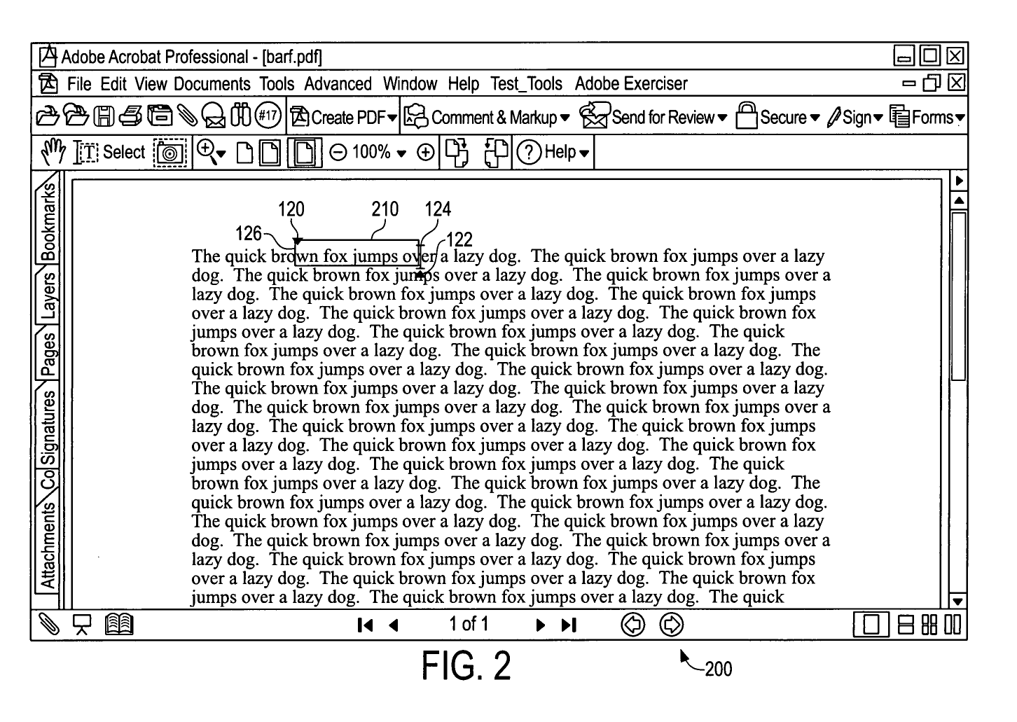

Referring now to FIG. 2, there is illustrated a screen shot 200 of selecting the placed downward pointing arrow handle 122 and repositioning the downward pointing arrow handle 122 to left of the first endpoint 126. It can be seen in FIG. 2 that while repositioning the downward pointing arrow handle 122 to the left of the first end point 126, the selected block of text data 210 is displayed in a first contrasting highlight. Similarly, it can be envisioned that the upward pointing arrow handle 120 could also have been used individually to reposition to right of the first end point 126 to make a different block of text selection. It can also be seen in the FIG. 2 that while repositioning the downward arrow handle 122, the upward pointing arrow handle 122 is held fixed at the second endpoint during the repositioning process.

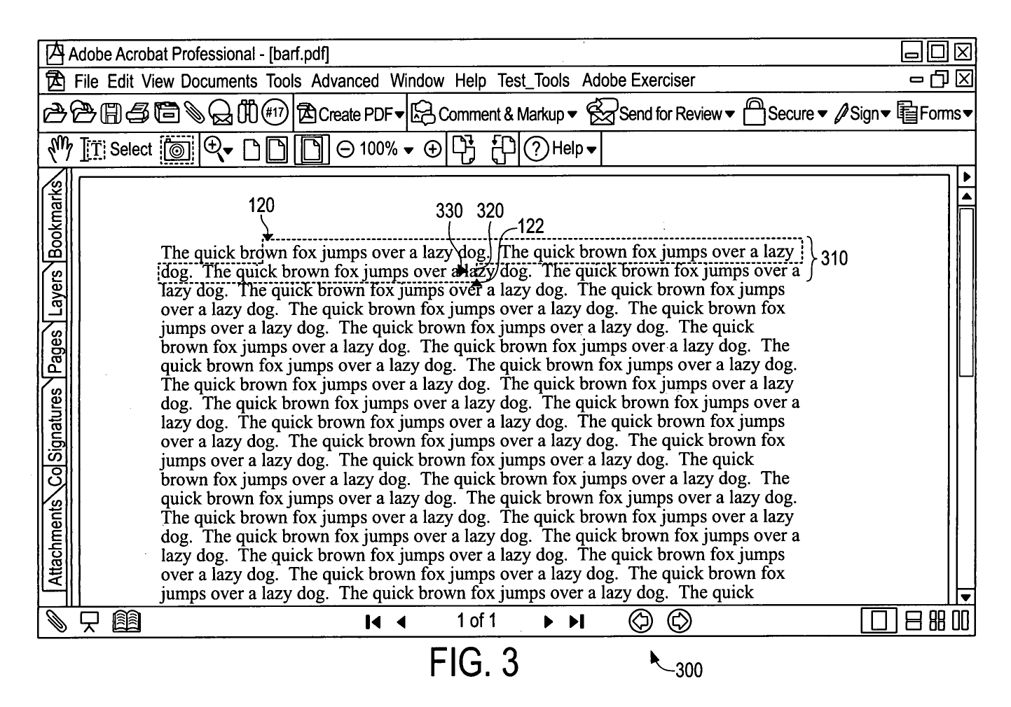

Referring now to FIG. 3, there is illustrated a screen shot 300 of placing the repositioned downward pointing arrow handle 122 at a second endpoint 320 to select a block of text data 310. After placing the repositioned downward pointing arrow handle 122 at the second endpoint 320 the selected block of text data 310 is displayed in a second contrasting highlight to indicate completion of the selection of the block of the text data 310. Also shown in FIG. 3 is a text selection cursor 330 that is available to select and manipulate individually either of the drag handles 120 and 122 upon completion of the selection of the block of text data 310.

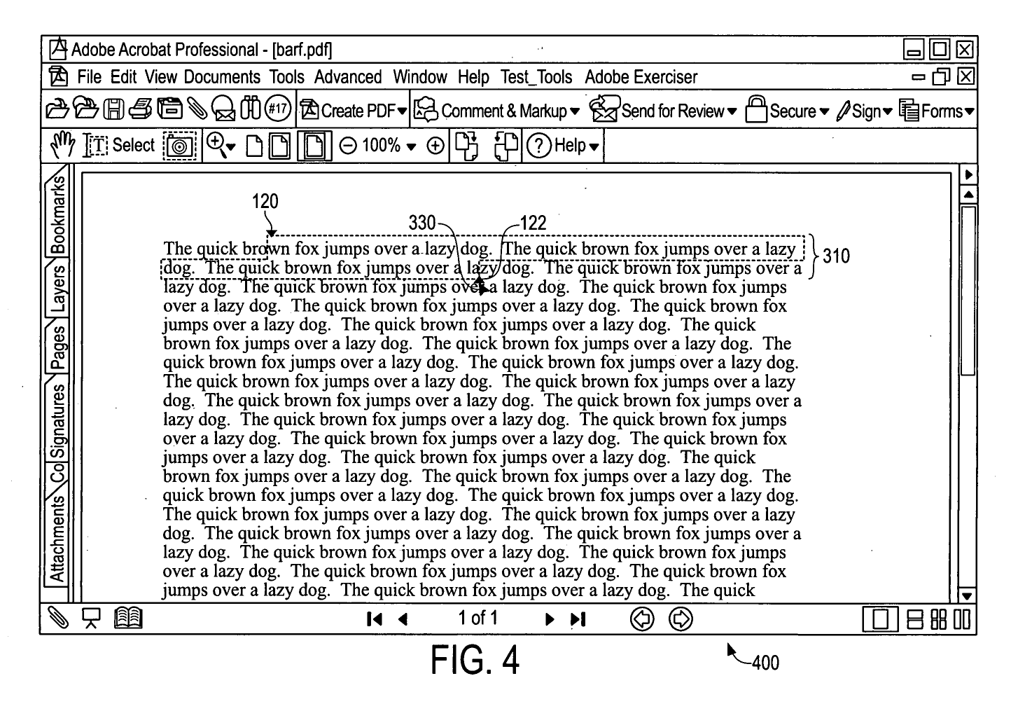

Referring now to FIG. 4, there is illustrated a screen shot 400 of positioning the text selection cursor 330 on the drag handle 122 to reposition the drag handle 122 to make a new block of text data selection. As shown in FIG. 4, it can be seen that the previous selection of the block of the text data 310 is still in the second contrasting highlight because the text selection cursor 330 is still not selected to start the repositioning of the drag handle 122. Similarly, it can be envisioned that at this stage the text selection cursor 330 could have been placed at the drag handle 120 to reposition the drag handle 120 to make a different block of text data selection.

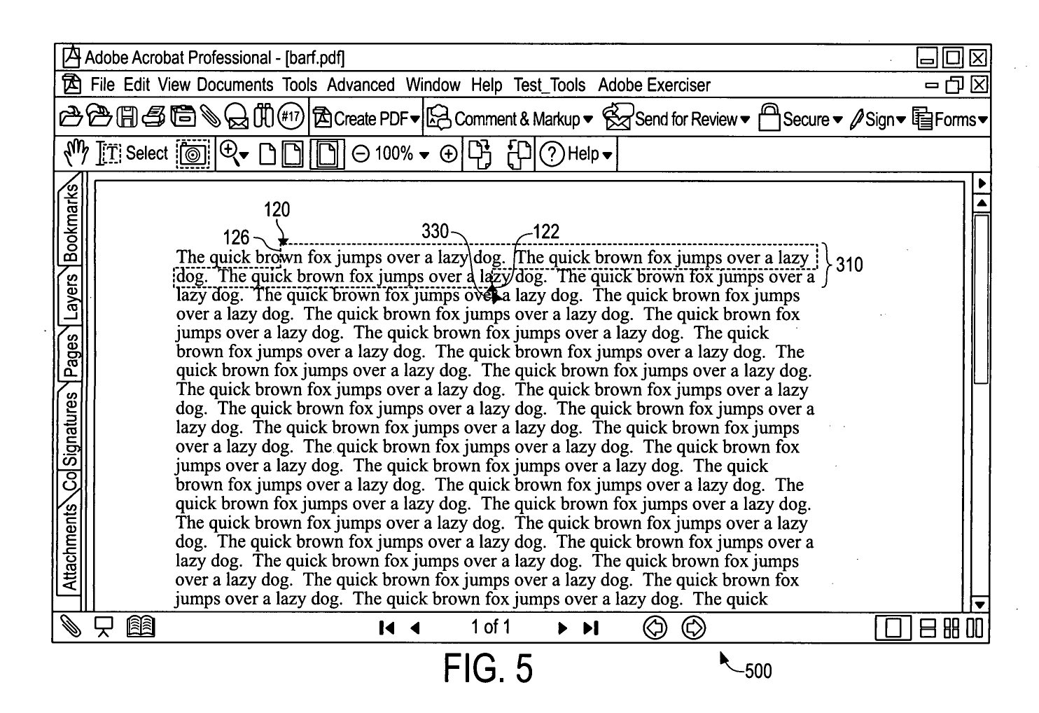

Referring now to FIG. 5, there is illustrated a screen shot 500 of selecting the upward pointing arrow handle 122 using the text selection cursor 330 placed at the upward pointing arrow handle 122 to start the process of repositioning the upward pointing arrow handle 122 to make a new block of text data selection. It can be seen that the selected block of text data 310 changes to the first contrasting highlight, in this case white-on-black, to indicate that the selected block of text data is being changed by repositioning of the upward pointing arrow handle 122 upon positioning the text selection cursor 330 at the upward pointing arrow handle 122 and selecting the upward pointing arrow handle 122.

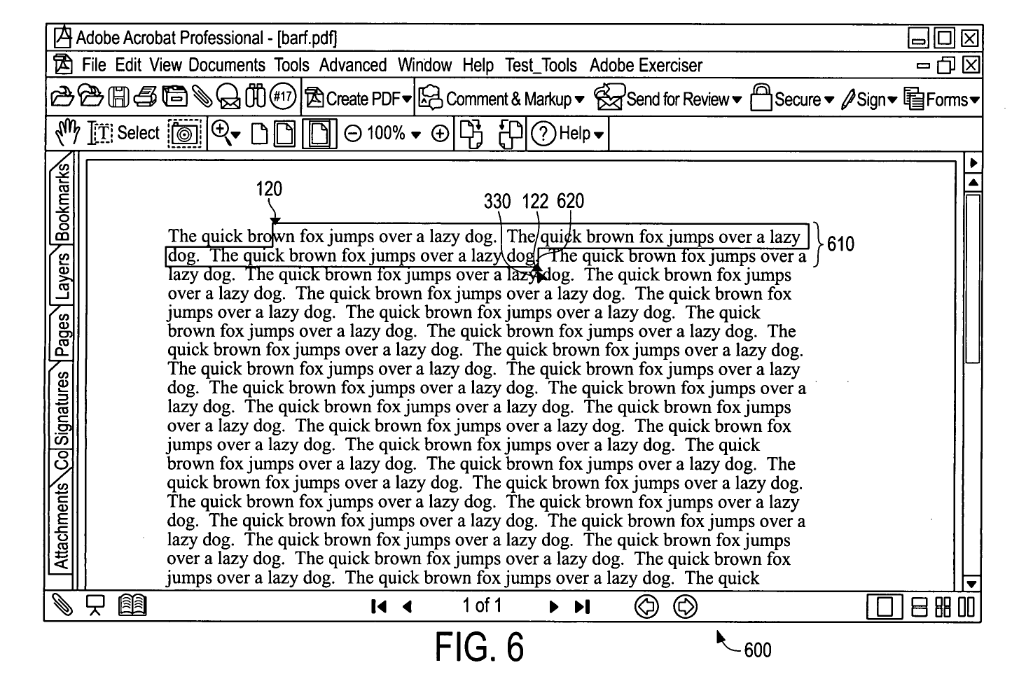

Referring now to FIG. 6, there is illustrated a screen shot 600 of repositioning the upward pointing arrow handle 122 to a new second endpoint 620 to make a new block of text data 610 selection. As shown in FIG. 6, the selected new block of text data 610 is still displayed in the first contrasting highlight to indicate that the selection of the new block of text data 610 is still not completed. Further as shown in FIG. 6, the upward pointing arrow handle 122 is repositioned to the right of the selected block of text data 310 (shown in FIG. 5) to select the end of the sentence. It can be envisioned that either of the drag handles 120 and 122 can be repositioned individually as described-above to select the new block of text data. Again it can be seen that while reposition the upward pointing arrow handle 122 to the new second endpoint 620, the downward pointing handle 120 in the first end point 126 is held fixed during the repositioning process.

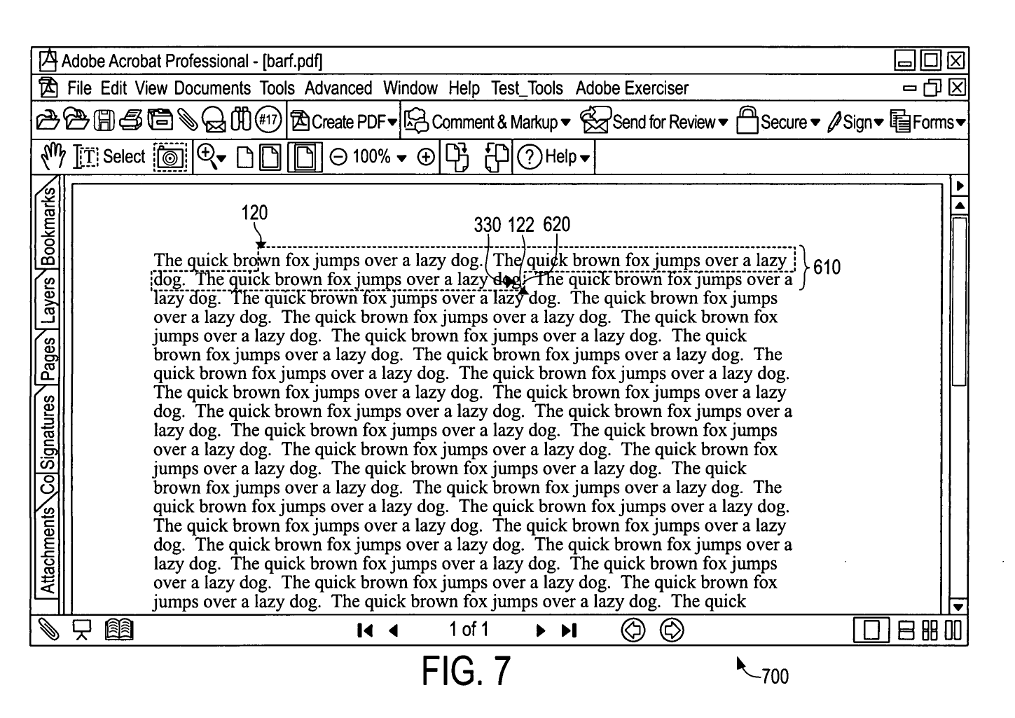

Referring now to FIG. 7, there is illustrated a screen shot 700 of completing the selection of the new block of text data 610 upon positioning the text selection cursor 330 at the new second endpoint 620 and selecting the text selection cursor 330 using the user input device. As shown in FIG. 7, it can be seen that upon completing the selection of the new block of text data 610, the newly selected block of text data 610 is displayed in the second contrasting light, in this case the white-on-black has changed to a system highlight, such as gray, to indicate completion of the selection of the new block of text data 610. At this point, it can be seen that the second endpoint 320 was repositioned to a new second endpoint 620 without having manipulated the first endpoint 126.

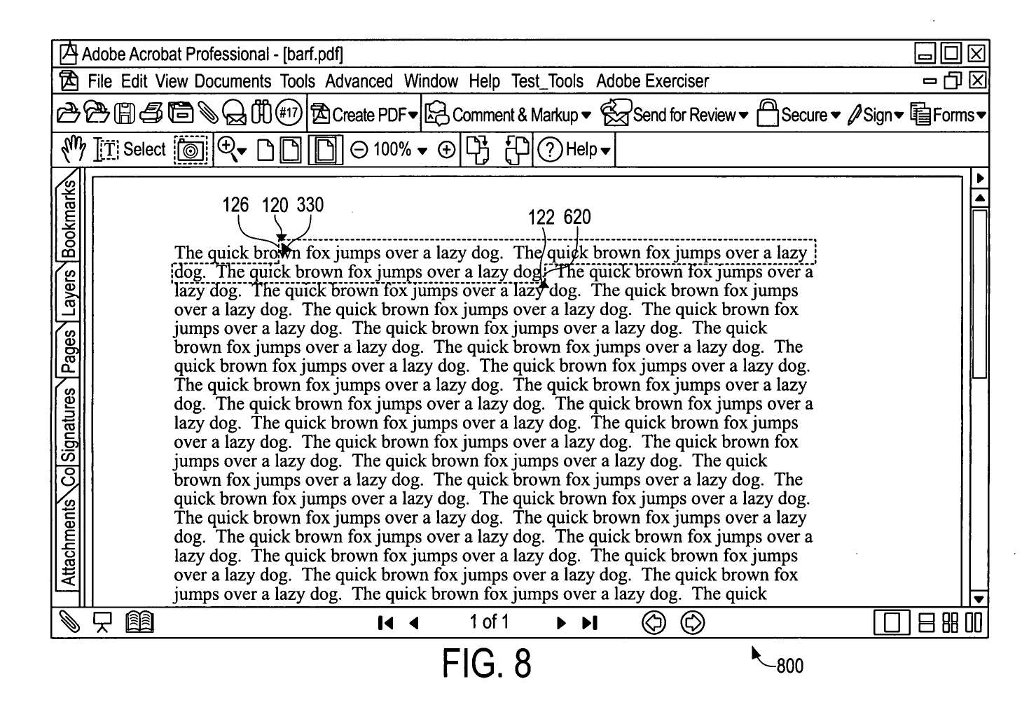

Referring now to FIG. 8, there is illustrated a screen shot 800 of positioning the text selection cursor 330 at the first endpoint 126 to reposition the drag handle 120, by manipulating the drag handle 120 using the text selection cursor 330, to revise the selected block of text data 610 to select a new block of text data. As shown in the FIG. 8, the selected block of text data 610 is still displayed in the second contrasting highlight to indicate that the text selection cursor 330 placed at the first endpoint 126 is still not selected to manipulate the first endpoint 126.

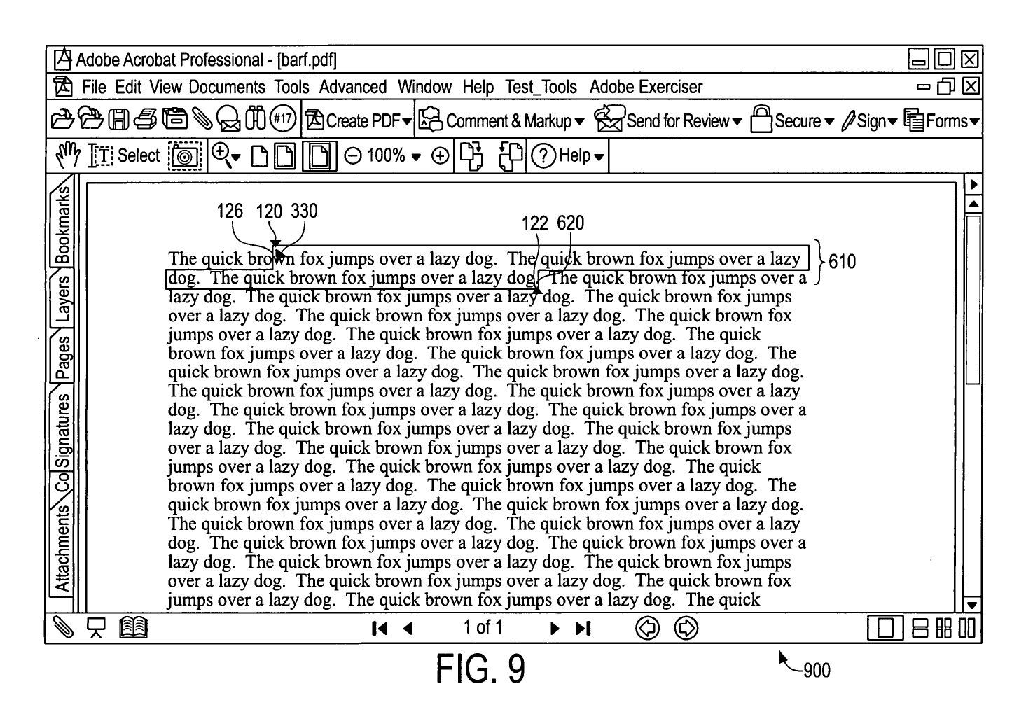

Referring now to FIG. 9, there is illustrated a screen shot 900 of selecting the first endpoint 126 for manipulating the drag handle 120 using the text control cursor 330 positioned at the drag handle 120. As shown in FIG. 9, the block of text data 610 is now displayed in the first contrasting highlight, i.e., white-on-black, to indicate that the selection of the first endpoint 126 is made and the drag handle 120 is ready for repositioning to revise the selected block of text data 610 to make a new block of text data selection.

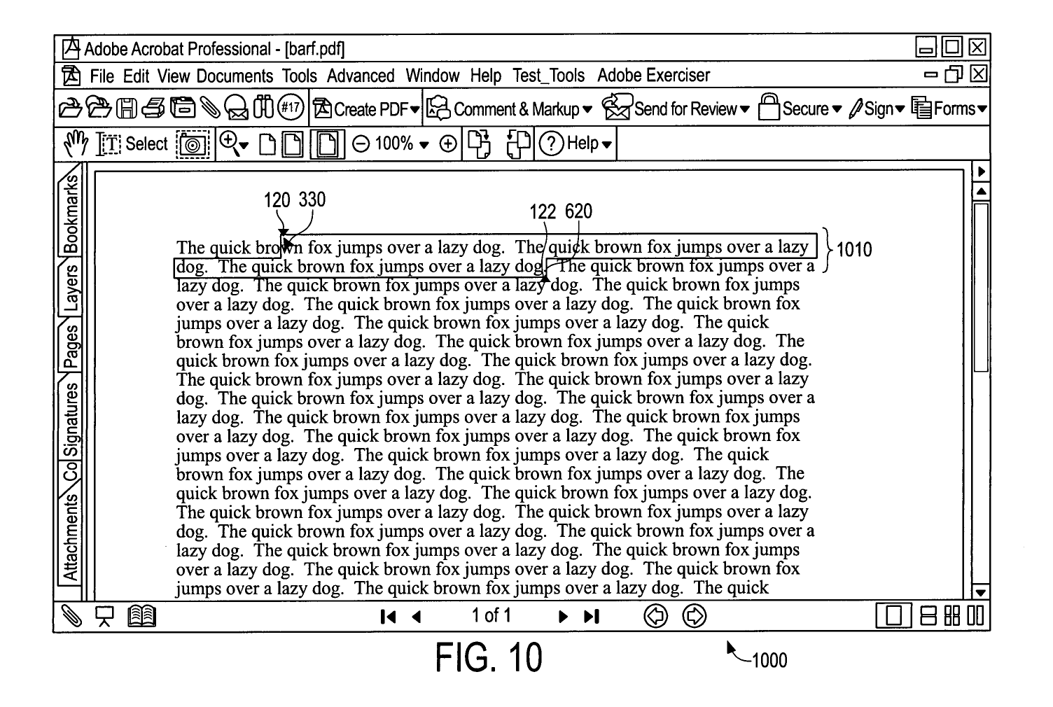

Referring now to FIG. 10, there is illustrated a screen shot 1000 of repositioning the drag handle 120 to select the new block of text data by dragging the text selection cursor 330 to the left of the selected block of text data using the user input device to select the rest of sentence. It can be seen in the screen shot 1000 that the selected block of text data 1010 remains displayed in the first contrasting highlight to indicate that the block of text data 1010 is still being revised. Similarly, it can be envisioned that the text selection cursor 330 could have dragged to the right of the selected block of text data as well to make a new selection.

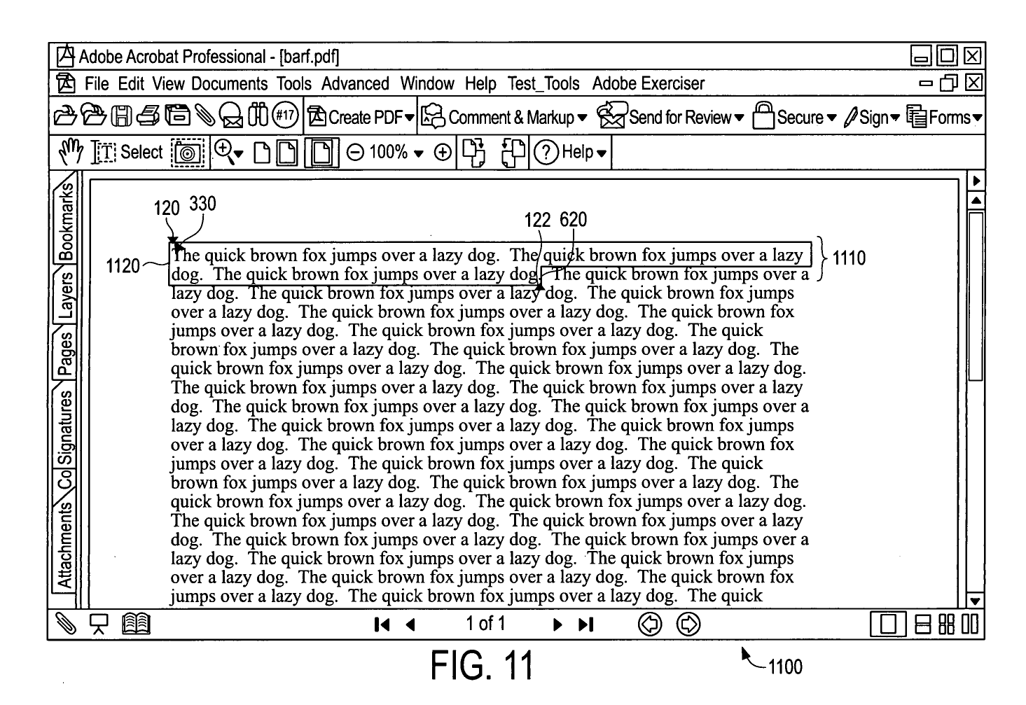

Referring now to FIG. 11, there is illustrated a screen shot 1110 of repositioning the drag handle 120 to a new first endpoint 1120 by dragging the text control cursor 330 to the beginning of the paragraph using the user input device. As shown in FIG. 11, the newly selected block of text data 1110 is still displayed in the first contrasting highlight to indicate that the text control cursor 330 needs to be selected at the newly positioned first endpoint 1120 to complete the selection of the new block of text data 1110.

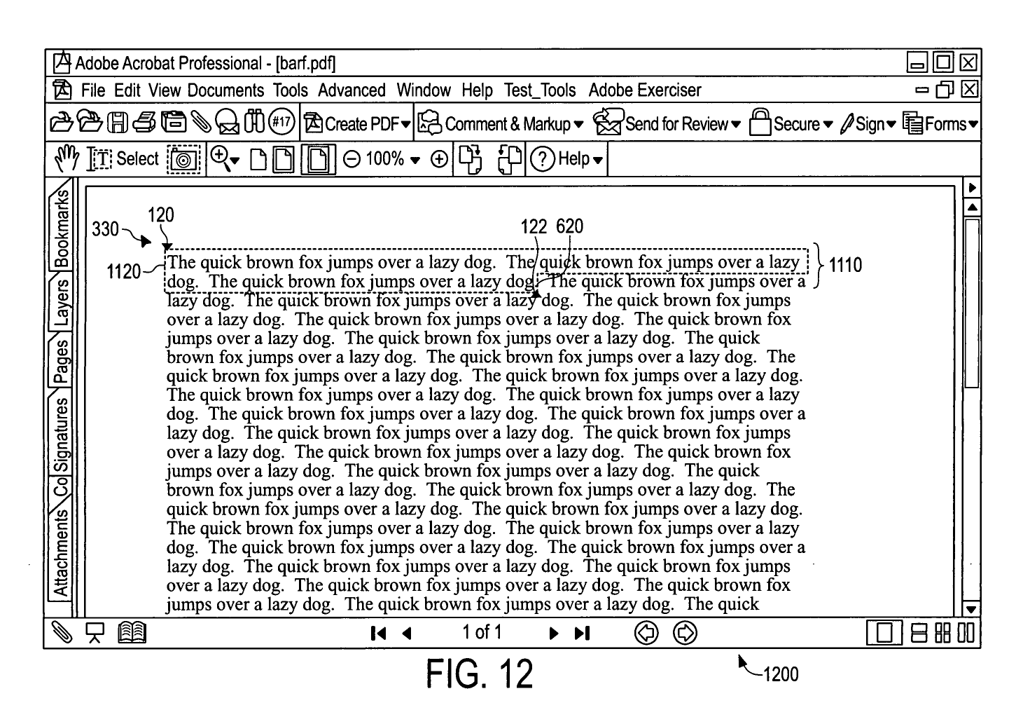

Referring now to FIG. 12, there is illustrated a screen shot 1200 of completing the selection of the new block of text data 1110 upon placing the drag handle 120 and releasing the text control cursor 330 at the drag handle 120 at the new first endpoint 1120. As shown in FIG. 12, the selected new block of text data 1110 is now displayed in the second contrasting highlight to indicate that the selection of the new block of text data is now completed. The second contrasting highlight can be of a different color, font, and/or style.

From the above screen shots 1-12 it can be clearly seen that the pair of drag handles 120 and 122 placed at first and second endpoints, 124 and 126, respectively, can be individually manipulated by using the text control cursor 330 to adjust the selected block of text data 310 to new blocks of text data 610 and 1110. Also, it can be seen from the screen shots shown in FIGS. 8-11 that the selected block of text data 610 can be adjusted by repositioning just the first endpoint 126 to a new position 1120 without having to manipulate the second endpoint 620.

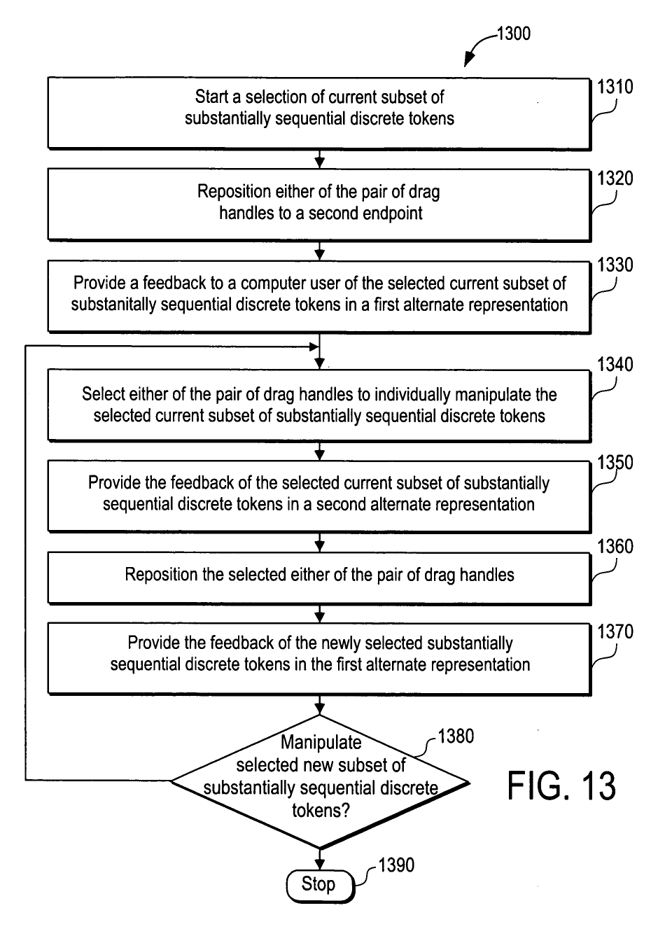

FIG. 13 illustrates a flowchart of an example method 1300 of performing an adjustment to either end of a selection of a subset of substantially sequential discrete tokens similar to the one shown in FIGS. 1-10. At 1310, selection of a current subset of substantially sequential discrete tokens form a set of available discrete tokens on a human interface device is started by placing a pair of drag handles at a first endpoint of the current subset of substantially sequential discrete tokens to be selected. In some embodiments, the subset of substantially discrete tokens is a block of text data. In other embodiments, the subset of substantially discrete tokens includes text elements, graphic elements, video elements, animated elements, and/or image elements. Generally, text selections are defined by two endpoints, one on either side of the text selections, and contains all of the elements between these two endpoints in a reading order.

At 1320, either of the pair of drag handles is placed at the first endpoint and repositioned individually using a user input device to complete the selection of the current block of substantially sequential discrete tokens. In these embodiments, the pair of drag handles is placed using the user input device, such as a mouse, a joystick, a digitizing tablet, and electronic stylus, a touch screen, a voice activated device and a trackball.

The pair of drag handles is a pair of interface adjustment elements that can be selected and manipulated on a human interface device, such as a display device using the user input device of a computer system. The pair of drag handles can be any symbol that can provide a cue to a computer user that the symbols can be individually manipulated. In these embodiments, the pair of drag handles is a downward pointing symbol and an upward pointing symbol. The downward pointing symbol and the upward pointing symbol provide a visual cue to indicate that an adjustment can be made to the selected block of text data by manipulating individually either of the downward pointing symbol and the upward pointing symbol. The upward pointing and the downward pointing symbols point to the endpoints of the selection. They can be designed to substantially allow a user to select and manipulate using the user input device but not large enough that they get in the way of manipulating the selected subset of substantially sequential discrete tokens. They can be designed to not to substantially obscure the selected block of text data.

At 1330, a feedback of the selected current subset of substantially sequential discrete tokens is provided in a first alternate representation to the computer user. The alternate representation can be representations, such as visual representation, a tactile representation, and an audio representation. In some embodiments, a visual feedback of the selected current subset of substantially sequential discrete tokens is provided in a first contrasting highlight to the computer user. The first contrasting highlight can be white-on-black discrete tokens on a display device, such as a computer screen. The first contrasting highlight can be a different color, font, and/or style.

In some embodiments, the selection of the current subset of substantially sequential discrete tokens is started using a combination of keys in a keyboard. The combination of keys is special keys in the keyboard that are capable of manipulating individually either of the pair of drag handles placed at the endpoints of the selected block of text data using a cursor. The special keys may be formed using keys, such as shift keys, ctrl keys, arrow keys, and/or function keys. In these embodiments, the pair of drag handles is placed at a first endpoint of the current subset of substantially sequential discrete tokens to be selected using the combination of keys in the keyboard. Also in these embodiments, either of the placed pair of drag handles is repositioned to a second endpoint of the current subset of substantially sequential discrete tokens using the combination of keys in the keyboard to complete the selection of the current subset of substantially sequential discrete tokens.

At 1340, either of the pair of drag handles placed at the first and second endpoints of the current subset of substantially sequential discrete tokens is selected to manipulate the selected current subset of substantially sequential discrete tokens. At 1350, a feedback of the selected current subset of substantially sequential discrete tokens is provided in a second alternate representation to indicate readiness to manipulate the selected current subset of substantially sequential discrete tokens. In some embodiments, the visual feedback of the selected current subset of substantially sequential discrete tokens is provided in a second contrasting highlight to the computer user. The first and second contrasting highlights can provide different levels of emphasis on the selected subset of substantially sequential discrete tokens to indicate readiness and selection. Further, the first and second contrasting highlights can be such that they can aid the computer user in selecting and manipulating the selected subset of substantially sequential discrete tokens.

At 1360, either of the pair of drag handles of the selected subset of substantially sequential discrete tokens is repositioned to select a new subset of substantially sequential discrete tokens. While repositioning the either one of the pair of drag handles, the other one of the pair of drag handles is held fixed during the repositioning process. At 1370, a feedback of the newly selected substantially sequential discrete tokens is provided in the first alternative representation to indicate completion of the selection of the new subset of substantially sequential discrete tokens. At 1390, the method 1300 checks whether the newly selected subset of substantially sequential discrete tokens needs further manipulation. If so, the method 1300 goes to act 1340. If there are no further manipulations required for the newly selected subset of substantially sequential discrete tokens then the method 1300 goes to act 1390 and stops the adjustment of selected subset of substantially sequential discrete tokens. The above-described operation of performing the adjustment to either endpoint of a selected subset of substantially sequential discrete tokens is described in more detail with reference to FIGS. 1-12.

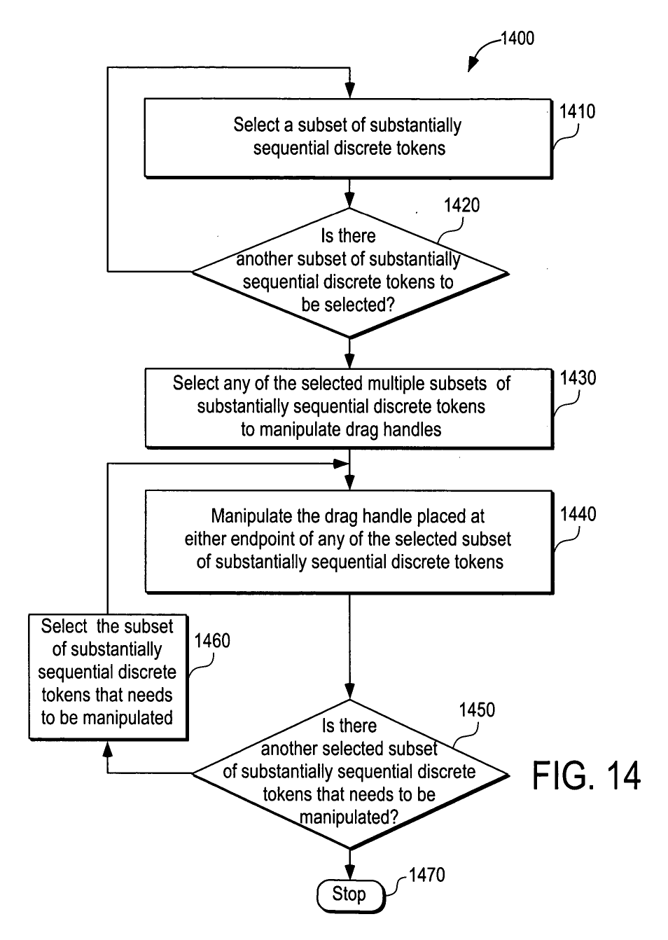

FIG. 14 illustrates a flowchart of an example method 1400 of performing an adjustment to either endpoint of each of multiple subsets of substantially sequential discrete tokens from a set of available discrete tokens according to the various embodiments of the present invention. At 1410, selection of a current subset of substantially sequential discrete tokens from the set of available discrete tokens on a display device is started by placing a drag handle on either side of the selection. At 1420, the method 1400 checks whether there is another subset of substantially sequential discrete tokens in the set of available discrete tokens that needs to be selected. If there is another subset of substantially sequential discrete tokens that needs to be selected, then the method 1400 goes to act 1410 and repeats the acts 1410-1420. If there are no other subsets of substantially sequential discrete tokens that need to be selected, then the method 1400 goes to 1430.

At 1430, in some embodiments, any one of the selected subsets of substantially sequential discrete tokens is selected for manipulating. At 1440, the drag handle placed at either endpoint of the selected subset of substantially sequential discrete tokens for manipulation is adjusted individually using a user input device to manipulate the selected subset of substantially sequential discrete tokens.

At 1450, the method 1400 checks whether there are any other selected subsets of substantially sequential discrete tokens that needs to be manipulated. If there is another selected subset of substantially sequential discrete tokens that needs to be manipulated, then the method 1400 selects the subset of substantially sequential discrete tokens that needs to be manipulated and goes to act 1440. If there are is no other selected subset of substantially sequential discrete tokens that needs to be manipulated, then the method 1400 goes to act 1470 and stops the selection and manipulation of the multiple subsets of substantially sequential discrete tokens. The process of selection and manipulation of the subset of substantially sequential discrete tokens is described in more detail with reference to FIGS. 1-13.

Although the flowcharts 1300 and 1400 include acts that are arranged serially in the exemplary embodiments, other embodiments of the subject matter may execute two or more blocks in parallel, using multiple processors or a single processor organized as two or more virtual machines or sub-processors. Moreover, still other embodiments may implement the blocks as two or more specific interconnected hardware modules with related control and data signals communicated between and through the modules, or as portions of an application-specific integrated circuit. Thus, the exemplary process flow diagrams are applicable to software, firmware, and/or hardware implementations.

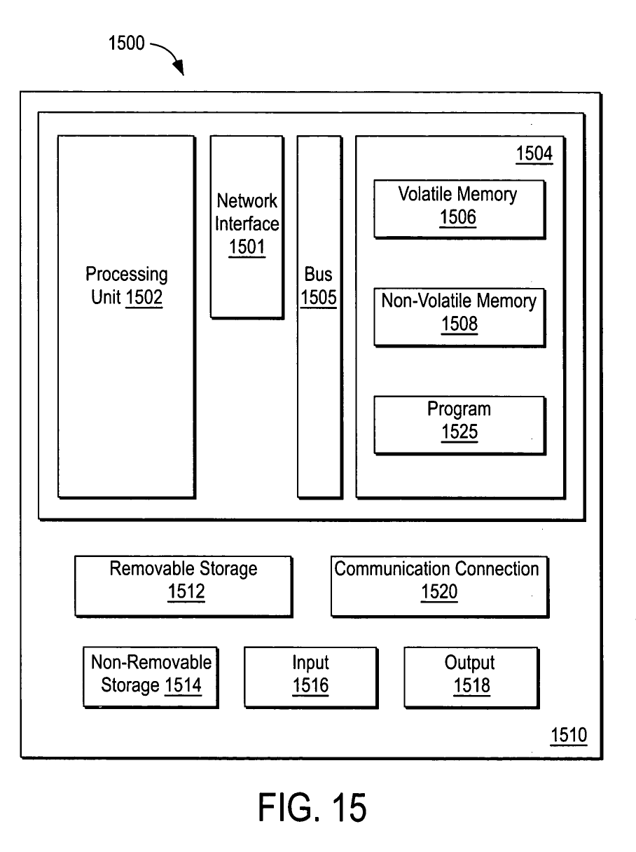

Various embodiments of the present invention can be implemented in software, which may be run in the environment shown in FIG. 15 (to be described below) or in any other suitable computing environment. The embodiments of the present invention are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present invention may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 15 shows a block diagram of a computing system that executes programming for performing the above functions. FIG. 15 and the following discussion are intended to provide a brief, general description of a suitable computing environment in which certain embodiments of the inventive concepts contained herein may be implemented.

A general computing device, in the form of a computer 1510, may include a processing unit 1502, memory 1504, removable storage 1512, and non-removable storage 1514. Computer 1510 additionally includes a bus 1505 and a network interface (NI) 1501.

Computer 1510 may include or have access to a computing environment that includes one or more input elements 1516, one or more output elements 1518, and one or more communication connections 1520 such as a network interface card or a USB connection. The computer 1510 may operate in a networked environment using the communication connection 1520 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 1504 may include volatile memory 1506 and non-volatile memory 1508. A variety of computer-readable media may be stored in and accessed from the memory elements of computer 1510, such as volatile memory 1506 and non-volatile memory 1508, removable storage 1512 and non-removable storage 1514. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present invention may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 1502 of the computer 1510. For example, a computer program 1525 may comprise machine-readable instructions capable of performing an adjustment to either endpoint of a set of discrete tokens selection according to the teachings and herein described embodiments of the present invention. In one embodiment, the computer program 1525 may be included on a CD-ROM and loaded from the CD-ROM to a hard drive in non-volatile memory 1508. The machine-readable instructions cause the computer 1510 to select and manipulate discrete tokens selection according to the embodiments of the present invention.

The graphical interface for manipulating substantially sequential discrete tokens of the present invention is modular and flexible in terms of implementation and usage. As a result, parts of the graphical interface of the present invention may be placed at different points of a network, depending on the model chosen. For example, the means to select and manipulate a subset of substantially sequential discrete tokens can be deployed in a server, and the input and output streamed over from a client to the server and back, respectively. A hub can also be placed on each client, with the database management centralized.

The above description is intended to be illustrative, and not restrictive. Many other embodiments will be apparent to those skilled in the art. The scope of the invention should therefore be determined by the appended claims, along with the full scope of equivalents to which such claims are entitled. The above-described methods and apparatus provide various embodiments for adjusting subsets of substantially sequential discrete tokens selection.

It is to be understood that the above-description is intended to be illustrative, and not restrictive. Many other embodiments will be apparent to those of skill in the art upon reviewing the above-description. The scope of the subject matter should, therefore, be determined with reference to the following claims, along with the full scope of equivalents to which such claims are entitled.

As shown herein, the present invention can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the method illustrated in FIGS. 13 and 14 can be performed in a different order from those shown and described herein.

FIGS. 1-15 are merely representational and are not drawn to scale. Certain proportions thereof may be exaggerated, while others may be minimized. FIGS. 1-15 illustrate various embodiments of the invention that can be understood and appropriately carried out by those of ordinary skill in the art.

The various embodiments of the present invention allow users to more easily create accurate text selections. Further, the present invention allows both endpoints of a selected text to be individually adjusted. In addition, the various embodiments of the present invention do not require any changes to the traditional way of dragging the cursor displayed on a display device to create text selections. This can significantly reduce the need for users to relearn the basics of the operation. Once a text selection is made, users can easily adjust individually either or both endpoints of the text selection.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of the embodiments of the invention, with each claim standing on its own as a separate preferred embodiment.

1. A computer implemented method comprising:
selecting a current subset of substantially sequential discrete tokens from a set of available substantially sequential discrete tokens by placing an interface adjustment element on each one of endpoints of the selected current subset of substantially sequential discrete tokens, and
wherein the interface adjustment element placed at either one of the endpoints is individually manipulatable while the interface adjustment element placed at the other one of the endpoints is being held fixed during the manipulation.

2. The method of claim 1, wherein the subset of substantially sequential discrete tokens comprises discrete tokens selected from the group consisting of text elements, graphic elements, video elements, animated elements, and image elements.

3. The method of claim 1, further comprising:
manipulating individually the interface adjustment element placed at either one of the endpoints while the interface adjustment element placed at the other one of the endpoints is being held fixed during the manipulation to select a next subset of substantially sequential discrete tokens.

4. The method of claim 2, further comprising:
providing a feedback of the selection during manipulation of the interface adjustment element placed at either one of the endpoints in a first alternate representation; and
providing a feedback of the selection in a second alternate representation to the computer user upon completing the selection of the next subset of substantially sequential discrete tokens.

5. The method of claim 4, wherein, in providing the feedback, the first alternate representation and second alternate representations comprise representations selected from the group consisting of a visual representation, a tactile representation, and an audio representation.

6. A computer implemented method for making an adjustment to a selected block of text data from an available text data, wherein at least a portion of the available text data is displayed on a display device of a computer system comprising:
starting a current block of text data selection by placing a pair of drag handles at a first endpoint of the current block of text data selection using a user input device, wherein the pair of drag handles comprise a downward pointing symbol and an upward pointing symbol, and wherein the downward pointing symbol and the upward pointing symbol provide a visual cue to indicate that an adjustment can be made to the current selected block of text data by manipulating individually either of the downward pointing symbol and the upward pointing symbol individually; and
repositioning the upward pointing symbol to a second endpoint of the current block of text data to be selected using the user input device to select of the current block of text data.

7. The method of claim 6, wherein the downward pointing symbol and the upward pointing symbol are a downward pointing arrow handle and an upward pointing arrow handle, respectively, wherein the downward pointing arrow handle and the upward pointing arrow handle are disposed around the first endpoint and the second endpoint of the selected current block of text data, respectively, to provide the visual feedback to a computer user that the adjustment to either of the first endpoint or the second endpoint can be made individually by manipulating the downward pointing arrow handle and the upward pointing arrow handle using the user input device.

8. The method of claim 7, wherein the downward pointing arrow handle and the upward pointing arrow handle substantially allow selecting and dragging by the computer user and not to substantially obscure the selected current block of text data from the computer user.

9. The method of claim 7, wherein the drag handles are interface adjustment elements that are displayed on the display device.

10. The method of claim 9, further comprising:
providing a visual feedback to the computer user of the selected current block of text data in a first contrasting highlight;
selecting either of the drag handles individually to manipulate the selected current block of text data;
providing a visual feedback of the selected current block of text data in a second contrasting highlight to indicate readiness to manipulate the selected current block of text data;
repositioning the selected drag handle to a next endpoint to select a next block of text data; and
providing the visual feedback of the next selected block of text data in the first contrasting highlight to indicate the completion of the selection of the next block of text data.

11. The method of claim 6, wherein, starting a current block of text data selection by placing a pair of drag handles at a first endpoint of the current block of text data selection using a user input device, the user input device comprises a device selected from the group consisting of a mouse, a joystick, a digitizing tablet, an electronic stylus, a touch screen, a voice activated device, and a trackball.

12. The method of claim 6, wherein selecting the current block of text data from a set of an available text data on a display device of a computer system by placing the pair of drag handles at the first endpoint of the current block of text data selection comprises:
starting the selection of the current block of text data by positioning the pair of drag handles at the first endpoint of the current block of text elements to be selected using a combination of keys in a keyboard; and
repositioning either of the pair of drag handles to a second endpoint of the current block of text data using the combination of keys to complete the selection of the current block of text data.

13. The method of claim 12, wherein the combination of keys is special keys in the keyboard capable of placing the drag handle and manipulating the drag handle at either endpoint of the selected current block of text data individually, wherein the special keys comprise keys selected from the group consisting of shift keys, ctrl keys, tab keys, arrow keys, and function keys.

14. A method of adjusting multiple subsets of substantially sequential discrete tokens from a set of available discrete tokens on a human interface device of a computer system comprising:
selecting a subset of substantially sequential discrete tokens from the set of available discrete tokens by placing a drag handle on either endpoint of the selected current subset of discrete tokens, and wherein the drag handle provides a cue to a computer user that the drag handle placed at either endpoint can be individually manipulated; and
repeating the selecting step for a next subset of substantially sequential discrete tokens form the set of available discrete tokens until all of the multiple subsets of substantially sequential discrete tokens are selected.

15. The method of claim 14, further comprising:
choosing one of the selected multiple subsets of substantially sequential discrete tokens for manipulation;
manipulating the drag handle placed at either endpoint of one of the selected subset of substantially sequential discrete tokens individually to adjust the selected subset of substantially sequential discrete tokens; and
repeating the above selecting and manipulating steps for another remaining selected multiple subsets of substantially sequential discrete tokens until all of the remaining multiple subsets of substantially sequential discrete tokens that needs to be manipulated are adjusted.

16. The method of claim 14, wherein selecting the current subset of substantially sequential discrete tokens comprises:
starting the selection of the current subset of substantially sequential discrete tokens by positioning a par of drag handles at a first endpoint of the current subset of discrete tokens to be selected using a user input device; and
repositioning one of the pair of drag handles to a second endpoint of the current subset of substantially sequential discrete tokens to be selected using the combination of keys to select the current subset of substantially sequential discrete tokens.

17. An article comprising:
a storage medium having instructions that, when executed by a computing platform, result in execution of a method comprising:
selecting a current subset of substantially sequential discrete tokens from a set of available discrete tokens on a human interface device by placing a interface adjustment element on either endpoint of the selected current subset of substantially sequential discrete tokens, and
wherein the interface adjustment element provides a cue to a computer user that either endpoint of the selected current subset of substantially sequential discrete tokens can be individually manipulated.

18. The article of claim 17, wherein the discrete tokens are elements from the group consisting of text elements, graphic elements, and image elements.

19. The article of claim 17, further comprising:
manipulating the interface adjustment element placed at either endpoint of the selected current subset of substantially sequential discrete tokens individually to select a next subset of substantially sequential discrete tokens.

20. The article of claim 19, further comprising:
providing a feedback of the selection in an alternate representation to the computer user upon selecting the next subset of substantially sequential discrete tokens.

21. The article of claim 20, wherein, in providing the feedback, the alternate representation comprises representations selected from the group consisting of a visual representation, a tactile representation, and an audio representation.

22. A computer system comprising:
a processing unit; and
a memory coupled to the processing unit, wherein the memory having instructions that, when executed by the processing unit, result in execution of a method comprising:
selecting a current subset of substantially sequential discrete tokens from a set of available discrete tokens on a human interface device by placing a interface adjustment element on either endpoint of the selected current subset of discrete tokens, and
wherein the interface adjustment element provides a cue to a computer user that the interface adjustment element placed at either endpoint can be individually manipulated.

23. The system of claim 22, wherein the substantially sequential discrete tokens are elements from the group consisting of text elements, graphic elements, and image elements.

24. The system of claim 22, further comprising:
manipulating the interface adjustment element placed at either endpoint individually to select a next subset of substantially sequential discrete tokens.
